(19) United States
(12) Patent Application Publication
(10) Pub. No.: US 2015/0228281 A1
(43) Pub. Date: Aug. 13, 2015

(54) DEVICE, SYSTEM, AND METHOD FOR ACTIVE LISTENING

(71) Applicant: FIRST PRINCIPLES,INC., Albany, NY (US)

(72) Inventor: Keith A. Raniere, Clifton Park, NY (US)

(73) Assignee: FIRST PRINCIPLES,INC., Albany, NY (US)

(21) Appl. No.: 14/174,986

(22) Filed: Feb. 7, 2014

(51) Int. Cl. G10L 17/22; G10L 15/28; G06F 3/16

(52) U.S. Cl. CPC G10L 17/22; G06F 3/167; G10L 15/28

(57) ABSTRACT

One or more electronic devices integrated over a network, wherein the one or more electronic devices continuously collect audio from an environment; wherein, when the system recognizes a trigger from the audio received by at least one of the one or more electronic devices, the received audio is processed to determine an action to be performed by the one or more electronic devices; wherein the system operates without any physical interaction of a user with the one or more electronic devices to perform the action is proved. An associated method and system for communication is further provided.

### FIELD OF TECHNOLOGY

The following relates to the field of telecommunications and more specifically to embodiments of a device, system, and method for hands-free interactivity with computing devices.

### BACKGROUND

Current methods of interactivity with computing devices require direct engagement with the computing device to perform a given task. For example, a user must physically interact with the device to place a phone call, send a text message or email, or otherwise send an electronic communication from the device. Similarly, the user must physically interact with the device to effectively receive a communication (e.g. open an email). This physical interaction with the device can be burdensome if the user's hands are occupied, or if the device is not within reach of the user. Moreover, typical environments contain multiple electronic devices that act independently from each other. Because these electronic devices are independent from each other, there is a lack of control and management of these devices.

Thus, a need exists for a device, system, and method for command and control of a digital system or device without requiring physical interaction from the user, and automatic management of data communication.

### SUMMARY

A first aspect relates to a system comprising: one or more electronic devices integrated over a network, wherein the one or more electronic devices continuously collect audio from an environment, wherein, when the system recognizes a trigger from the audio received by at least one of the one or more electronic devices, the received audio is processed to determine an action to be performed by the one or more electronic devices; wherein the system operates without any physical interaction of a user with the one or more electronic devices to perform the action.

A second aspect relates to a method for hands-free interaction with a computing system, comprising: continuously collecting audio from an environment by one or more integrated electronic devices, recognizing, by a processor of the computing system, a trigger in the audio collected by the one or more integrated electronic devices, after recognizing the trigger, determining, by the processor, a command event to be performed, checking, by the processor, one or more filters of the computing system, and performing, by the processor, the command event.

A third aspect relates to a computer program product comprising a computer-readable hardware storage device having computer-readable program code stored therein, said program code configured to be executed by a processor of a computer system to implement a method for encoding a connection between a base and a mobile handset, comprising: continuously collecting audio from an environment by one or more integrated electronic devices, recognizing, by a processor of the computing system, a trigger in the audio collected by the one or more integrated electronic devices, after recognizing the trigger, determining, by the processor, a command event to be performed, checking, by the processor, one or more filters of the computing system, and performing, by the processor, the command event.

A fourth aspect relates to a system for hands-free communication between a first user and a second user, comprising: a system of integrated electronic devices associated with the first user, the system continuously processing audio from the first user located in a first environment, wherein, when the system recognizes a trigger to communicate with the second user located in a second environment, a communication channel is activated between at least one of the integrated devices and a device of the second user to allow the first user to communicate with the second user, wherein the first user does not physically interact with any of the integrated electronic devices to establish the communication channel to communicate with the second user.

A fifth aspect relates to a method of communicating between a first user and a second user, comprising: continuously collecting and processing audio, by one or more integrated electronic devices forming an integrated system associated with the first user, from the first user located in a first environment, and after a trigger is recognized to communicate with the second user located in a second environment, activating a communication channel between at least one of the integrated electronic devices and a device of the second user to allow the first user to communicate with the second user, wherein the first user does not physically interact with any of the integrated electronic devices to establish the communication channel to communicate with the second user.

A sixth aspect relates to a computer program product comprising a computer-readable hardware storage device having computer-readable program code stored therein, said program code configured to be executed by a processor of a computer system to implement a method for encoding a connection between a base and a mobile handset, comprising: continuously collecting and processing audio, by one or more integrated electronic devices forming an integrated system associated with the first user, from the first user located in a first environment, and after a trigger is recognized to communicate with the second user located in a second environment, activating a communication channel between at least one of the integrated electronic devices and a device of the second user to allow the first user to communicate with the second user, wherein the first user does not physically interact with any of the integrated electronic devices to establish the communication channel to communicate with the second user.

### BRIEF DESCRIPTION OF THE DRAWINGS

Some of the embodiments will be described in detail, with reference to the following figures, wherein like designations denote like members, wherein:

FIG. 1 depicts a schematic view of an embodiment of a computing device;

FIG. 2 depicts a schematic view of an embodiment of the computing device connected to other computing devices over a network;

FIG. 3 depicts a flowchart of an embodiment of a system performing a command event;

FIG. 4 depicts a flowchart of an embodiment of the system verifying a command event;

FIG. 5 depicts a flowchart of an embodiment of the system being used for communication; and

FIG. 6 depicts a flowchart of an embodiment of a system developing system intelligence.

### DETAILED DESCRIPTION

A detailed description of the hereinafter described embodiments of the disclosed system and method are presented herein by way of exemplification and not limitation with reference to the Figures. Although certain embodiments of the present invention will be shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

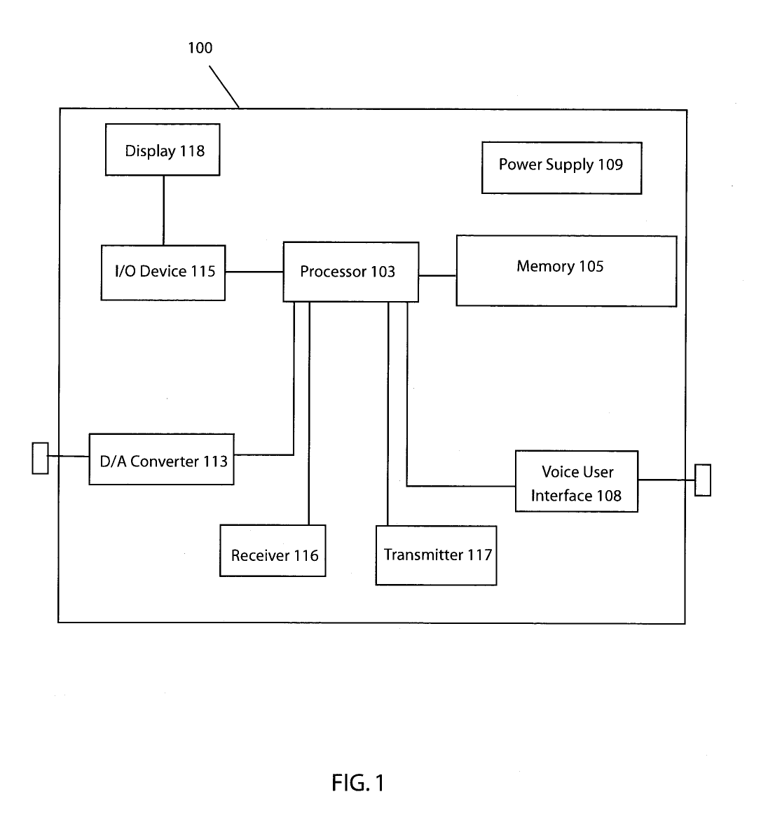

FIG. 1 depicts an embodiment of an electronic device 100. Embodiments of electronic device 100 may be any electronic device, computing system, digital system, electric device, and the like. Embodiments of electronic device 100 may be desktop computers, laptops, tablets, chromebooks, smartphones, other mobile or cellular phones, internet connected televisions, internet connected thermostats, video game consoles, home entertainment systems, smart home appliances, smart wristwatches, internet connected eyeglasses, media player devices such as an iPod® or iPod-like devices, home or business security systems, electronic door locks, switches, garage door opener, remote engine starters, electric fireplaces, media devices integrated with automobiles, stand-alone audio input device, microphone, digital recorder, and the like. Electronic device 100 may include a processor 103, a local storage medium, such as computer readable memory 105, and an input and output interface 115. Embodiments of electronic device 100 may further include a display 118 for displaying content to a user, a digital-to-analog converter 113, a receiver 116, a transmitter 117, a power supply 109 for powering the computing device 100, and a voice user interface 108.

Embodiments of processor 103 may be any device or apparatus capable of carrying out the instructions of a computer program. The processor 103 may carry out instructions of the computer program by performing arithmetical, logical, input and output operations of the system. In some embodiments, the processor 103 may be a central processing unit (CPU) while in other embodiments, the processor 103 may be a microprocessor. In an alternative embodiment of the computing system, the processor 103 may be a vector processor, while in other embodiments the processor may be a scalar processor. Additional embodiments may also include a cell processor or any other existing processor available. Embodiments of an electronic device 100 may not be limited to a single processor 103 or a single processor type, rather it may include multiple processors and multiple processor types within a single system that may be in communication with each other.

Moreover, embodiments of the electronic device 100 may also include a local storage medium 105. Embodiments of the local storage medium 105 may be a computer readable storage medium, and may include any form of primary or secondary memory, including magnetic tape, paper tape, punch cards, magnetic discs, hard disks, optical storage devices, flash memory, solid state memory such as a solid state drive, ROM, PROM, EPROM, EEPROM, RAM, and DRAM. Embodiments of the local storage medium 105 may be computer readable memory. Computer readable memory may be a tangible device used to store programs such as sequences of instructions or systems. In addition, embodiments of the local storage medium 105 may store data such as programmed state information, and general or specific databases. Moreover, the local storage medium 105 may store programs or data on a temporary or permanent basis. In some embodiments, the local storage medium 105 may be primary memory while in alternative embodiments, it may be secondary memory. Additional embodiments may contain a combination of both primary and secondary memory. Although embodiments of electronic device 100 are described as including a local storage medium, it may also be coupled over wireless or wired network to a remote database or remote storage medium. For instance, the storage medium may be comprised of a distributed network of storage devices that are connected over network connections, and may share storage resources, and may all be used in a system as if they were a single storage medium.

Moreover, embodiments of local storage medium 105 may be primary memory that includes addressable semi-conductor memory such as flash memory, ROM, PROM, EPROM, EEPROM, RAM, DRAM, SRAM and combinations thereof. Embodiments of device 100 that includes secondary memory may include magnetic tape, paper tape, punch cards, magnetic discs, hard disks, and optical storage devices. Furthermore, additional embodiments using a combination of primary and secondary memory may further utilize virtual memory. In an embodiment using virtual memory, a device 100 may move the least used pages of primary memory to a secondary storage device. In some embodiments, the secondary storage device may save the pages as swap files or page files. In a system using virtual memory, the swap files or page files may be retrieved by the primary memory as needed.

Referring still to FIG. 1, embodiments of electronic device 100 may further include an input/output (I/O) interface 115. Embodiments of the I/O interface 115 may act as the communicator between device 100 and the world outside of the device 100. Inputs may be generated by users such as human beings or they may be generated by other electronic devices and/or computing systems. Inputs may be performed by an input device while outputs may be received by an output device from the computing device 100. Embodiments of an input device may include one or more of the following devices: a keyboard, mouse, joystick, control pad, remote, trackball, pointing device, touchscreen, light pen, camera, camcorder, microphone(s), biometric scanner, retinal scanner, fingerprint scanner or any other device capable of sending signals to a computing device/system. Embodiments of output devices may be any device or component that provides a form of communication from the device 100 in a human readable form, such as a speaker. Embodiments of a device 100 that include an output device may include one or more of the following devices: displays, smartphone touchscreens, monitors, printers, speakers, headphones, graphical displays, tactile feedback, projector, televisions, plotters, or any other device which communicates the results of data processing by a computing device in a human-readable form.

With continued reference to FIG. 1, embodiments of the electronic device 100 may include a receiver 116. Embodiments of a receiver 116 may be a device or component that can receive radio waves and other electromagnetic frequencies and convert them into a usable form, such as in combination with an antenna. The receiver 116 may be coupled to the processor of the electronic device 100. Embodiments of the receiver 116 coupled to the processor 103 may receive an electronic communication from a separate electronic device, such as device 401, 402, 403 over a network 7.

Moreover, embodiments of the electronic device 100 may include a voice user interface 108. Embodiments of a voice user interface 108 may be a speech recognition platform that can convert an analog signal or human voice communication/signal to a digital signal to produce a computer readable format in real-time. One example of a computer readable format is a text format. Embodiments of the voice user interface 108 or processor(s) of system 200 may continually process incoming audio, programmed to recognize one or more triggers, such as a keyword or command by the user operating the electronic device 100. For example, embodiments of the voice user interface 108 coupled to the processor 103 may receive a voice communication from a user without a physical interaction between the user and the device 100. Because the voice user interface or processor(s) of system 200 may continually process and analyze incoming audio, once the voice user interface 108 recognizes a trigger/command given by the user, the processor coupled thereto determines and/or performs a particular action. The continuous processing of audio may commence when the electronic communication is first received, or may be continuously processing audio so long as power is being supplied to the electronic device 100. Furthermore, embodiments of the voice user interface 108 may continuously collect and process incoming audio through one or more microphones of the device 100. However, external or peripheral accessories that are wired or wirelessly connected to the device 100 may also collect audio for processing by the processor 103 of the device 100. For instance, an environment, such as a household, office, store, may include one or more microphones or other audio collecting devices for capturing and processing audio within or outside an environment, wherein the microphones may be in communication with one or more processors 103 of one or more devices of system 200. Embodiments of the collected and processed audio may be the voice of the user of the device 100, and may have a variable range for collecting the audio.

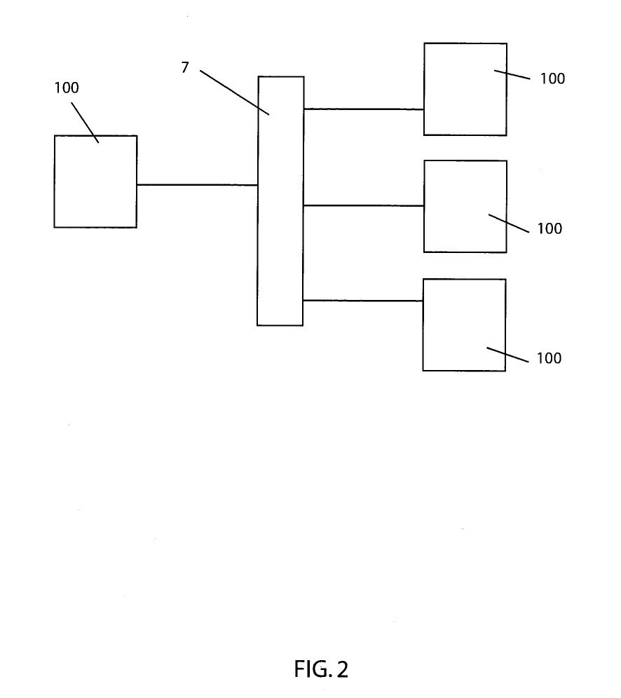

With continued reference to the drawings, FIG. 2 depicts an embodiment of an integrated system 200. Embodiments of an integrated system may include one or more electronic devices, such as electronic devices 100, that are interconnected, wired or wirelessly. In other words, the system 200 may be integrated across each user device. The system 200 may further be integrated with any other device or system with computer-based controls or signal receiving means. System 200, and associated method steps, may be embodied by a single device 100, in addition to multiple devices. Moreover, embodiments of system 200 may be constantly determining if it should process a pre-set action or determine an action to take based on algorithmically or otherwise derived decisions by the system 200 based on pre-set commands or independent of pre-set commands. Embodiments of system 200 may constantly, or otherwise, be listening to one or more users by capturing audio in an environment. For instance, one or more, including all, of the user's devices 100 may be capturing, receiving, collecting, etc. audio from an environment. Further, audio from an environment may be captured by one or microphones placed around the environment, wherein the microphones are connected to and integrated with the system 200 or at least one of the devices 100 of the system 200.

Embodiments of the system 200 may be comprised of one or more electronic devices 100, wherein each device 100 may be a component or part of the integrated system 200. The integrated system 200 may be a computing system having a local or remote central or host computing system, or may utilize a processor 103 of the device 100, or multiple processors from multiple devices to increase processing power. The integrated system 200 may be configured to connect to the Internet and other electronic devices over a network 7, as shown in FIG. 2. Embodiments of the network 7 may be a cellular network, a Wi-Fi network, a wired network, Internet, an intranet, and the like, and may be a single network or comprised of multiple networks. For instance, a first plurality of electronic devices 100 of system 200 may be connected to each other over a first network, such as a LAN or home broadband network, while being connected to a second plurality of electronic devices of system 200 over a second network, such as over a cellular network. A plurality of networks 7 may include multiple networks that are the same type of networks (e.g. a Wi-Fi type network in two, separate geographical locations). Each device 100 forming part of the integrated system 200 may also be connected to each other on the same network.

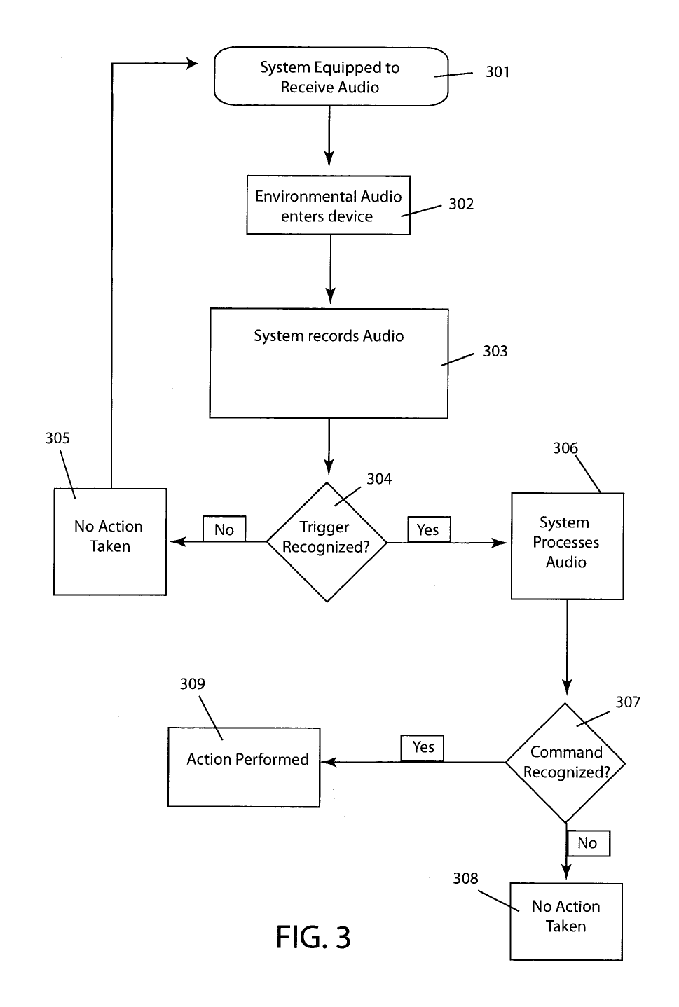

FIG. 3 depicts a flowchart of at least one embodiment of a method 300 of operation of system 200. As shown by Step 301, at least one electronic device 100 may be configured to or be capable of collecting real-world signals from an environment. Embodiments of a real-world signal may be sound, audio, a physical property, temperature, humidity, voices, noise, lights, and the like For instance, at least one device 100 may include one or more microphones to collect audio from an environment. In some embodiments, multiple devices 100 located within an environment may include microphones for collecting audio from the environment. In another embodiment, all devices 100 may include microphones for collecting audio from the environment. Moreover, the environment may be a fixed or stationary environment, such as a household, or may be a dynamic or mobile environment, such as the user's immediate surroundings as the user is in motion or geographically relocates, or an automobile. Real-world signals, such as audio, may also be collected by the device(s) 100 in multiple environments, wherein the multiple environments are geographically separated, designed for a particular user, or are otherwise different. For example, a smartphone integrated with system 200 that is located in a user's pocket at his/her office may be collecting audio in that environment, yet an internet connected TV located at his/her home may be collecting audio from that environment. As another example, one or more devices 100 may collect audio from an area located external to an environment; one or more device 100 may be located on a front porch or near a garage outside of a house for collecting audio.

Because at least one device 100 of system 200 is collecting, capturing, receiving, etc., audio or other real-world signals from an environment, the signal enters the device 100, as indicated by Step 302. The device(s) 100 may constantly or continuously listen for audio such that any audio or real-world signal generated within the environment is captured by the device 100 of system 200. As the audio enters the device 100 or system 200, the audio may be recorded, as indicated by Step 303. For instance, audio input may be permanently stored, temporarily stored, or archived for analysis of the received audio input. However, analysis may be performed immediately and/or real-time or near real-time even if the audio is to be stored on the device(s) 100. The received audio input may be discarded after a certain period of time or after an occurrence or non-occurrence of an event. In some embodiments, the incoming audio is not recorded, and the analysis of the incoming audio may be performed instantly in real-time or near real-time. Analysis of the incoming, received audio or real-world signal (whether recorded/stored or not) may be performed by the processor 103 of the device 100, by a processor of a remote processor of the system 200, a processor of another device 103 integrated within system 200, or any combination thereof. Embodiments of the analysis of the received audio may include determining whether/if a trigger is present or recognized in the collected audio, as shown at Step 304. For instance, the device 100 or system 200 may process the received audio entering the device 100, stored or otherwise, to determine if a trigger exists. The processing and/or the analyzing of the audio input may be done through transcription, signal conversion, audio/voice-to-text technology, or audio-to-computer readable format, either on the device 100 or another device 100 locally or remotely, and wired or wirelessly integrated or otherwise connected to system 200. Embodiments of a trigger may be a recognizable or unique keyword, event, sound, property, pattern, and the like, such as a voice command from a user, a volume threshold, a keyword, a unique audio input, a cadence, a pattern, a song, a ringtone, a text tone, a doorbell, a knock on a door, a dog bark, a GPS location, a motion threshold, a phrase, a proper noun (e.g. name of person, place of business etc.), an address, a light, a temperature, a time of day, or any spoken word or perceptible sound that has a meaning relative to or learned by the system 200. Embodiments of threshold triggers may include a certain threshold or level of real-word signal, such as audio/volume, that if below the threshold, the system 200 or one of the device 100, such as smartphone, does not continuously record to reduce power consumption. However, if the volume threshold in the environment is above the threshold, then the system 200 and/or device 100 may continuously collect the audio from the environment. Triggers may be pre-set system defaults, manually inputted into the system 200 by the user or operators of the system 200 or device 100, or may be automatically developed and generated by system intelligence, described in greater detail infra.

If a trigger is not recognized, then potentially no further action is taken, and the device 100 continues to collect audio from the environment, as indicated by Step 305. If a trigger is recognized, then the system 200 may process, or further process and analyze, the audio input collected from the environment, as shown at Step 306. This processing may be done by the local processor 103 of device 100 that collected the audio, or may be processed remotely. In further embodiments, in the event that multiple devices 100 are located in the same environment capable of recognizing a trigger such that multiple devices 100 may collect the same audio and recognize the same trigger, the system 200 may dictate that some processors 103 of some of the devices 100 continue processing the audio, while others resume (or never cease) listening for audio in the environment. This delegation may be automatically performed by the system 200 once more than one integrated device 100 is detected to be within the audible environment. In Step 307, the system 200 or device 100 determines whether a command event is recognized, based on the processing of the audio input after a trigger was recognized. Embodiments of a command event may be an action to be performed by one or more devices 100 of the integrated system 200 as directed, asked, requested, commanded, or suggested by the user. The command event may be a command, a reaction, a task, an event, and the like, and may be pre-set, manually inputted into the system 200 by the user or operators of the system 200, or may be automatically developed generated by system intelligence, described in greater detail infra. For example, embodiments of a command event may be a voice command by the user, a question or request from the user, a computer instruction, and the like. A further list of examples may include:
Phone rings, user says “send to voicemail”
Phone rings, user says “who is it?” and the system 200 responds to question, and the user can then direct the system 200 to act based on the response from the system 200
User says, “find me data on ‘X’ topic,” and the system 200 returns search results (the system may display the data to the user in various formats, such as audio, text, audio/visual, etc.)
User says, “find all my emails about snowboarding,” and the system finds and displays the emails to the user on a display on one or more devices integrated with the system 200
User says, “send my client a file,” and the system 200 sends the file, either from one of the devices 100 of the system 200
   If a command event is not recognized by the system 200, potentially no action is taken, and the device(s) 100 continue listening for audio within the environment, as shown at Step 308.

However, if a command event is recognized, then system 200 may perform the action or carry out the instruction associated with the command event, as noted at Step 309. The action may be performed by a single device 100, multiple devices 100, the device 100 that captured the audio, or any device 100 connected to the system 200. System 200 may determine which device 100 is the most efficient to complete the action, or which device 100 is specifically designated to accomplish the required action. For instance, if the user requests that a temperature in the living room be lowered, the system 200 may determine that the thermostat, which is connected to system 200, should perform this action, and a signal may be sent accordingly. Because the devices 100 of system 200 may be continuously listening in on an environment, collecting any audio or other real-world signals from that environment, it may not be required that a user physically interact with a device 100 in order for the device 100, or other devices 100 to perform an action, such as a command event. For example, as described above, one or more devices 100 may capture audio input through a microphone or microphone like device from an environment, interpret a content of the received audio from the environment to determine if an action should be performed by the system 200 through a recognition of a command event, without physical engagement or touching the device 100.

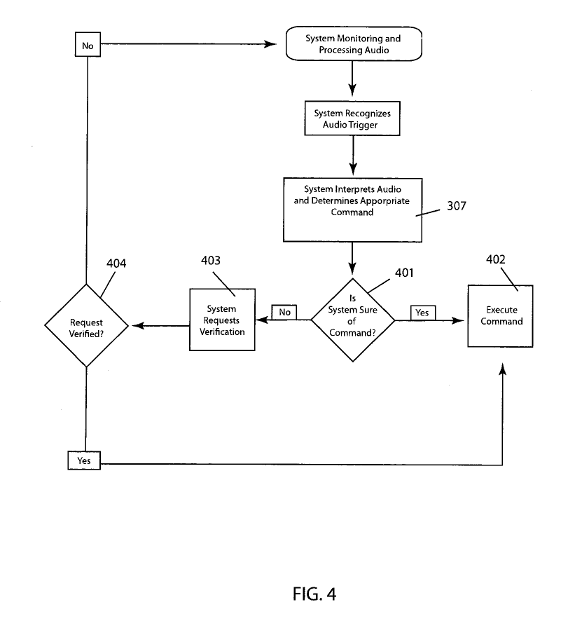

Referring now to FIG. 4, system 200 may verify a command event or an action to be taken/performed. Embodiments of the system 200 may recognize a command event, as noted in Step 307. However, system 200 may perform a verification and/or clarification process, starting at Step 401. First, the system 200 may question it is sure of the command event, as indicated at Step 401. If the system 200 is sure of the command event, then the system 200 or device 100 may execute the command event, as shown at Step 402. If the system 200 is unsure of the command event, the system 200 may request verification or request further clarification, as indicated at Step 403. The system 200 may request verification, clarification, or confirmation from the user or from other devices 100 of the system prior to executing the command event. In one embodiment, the system 200 may audibly or textually ask a yes or no question as it relates to the particular command event, or may ask for a passcode to be stated by the user before performing the action. In another embodiment, the system 200 may display the command event and allow the user to answer yes or no (i.e. confirm or deny). In other embodiments, the system 200 may search other software programs stored at least one of the devices 100, such as a web browser, or calendar program, to verify a command event. In yet another embodiment, system 200 may perform more than one method of verification, including the specific embodiments set forth herein, and may include other verification procedures. For clarification requests, the system 200 may audibly or textually ask a follow-up question to the user. At Step 404, the system 200 may determine if the request for verification/clarification has been received. If the request for verification has been received in the affirmative, or the command event has been clarified, the system 200 may perform an action/command event, as noted in Step 402.

Accordingly, a user may operate device 100 that can be integrated or part of system 200 to directly interact with the system 200. The direct interaction with the system 200 by the user may be done without physical interaction. For instance, without physically picking up the phone and touching the device, a user may interact with the device 100 in a plurality of ways for performance of a task. Embodiments of system 200 could be integrated with any computer-driven system to enable a user to run any commands verbally. Because the system 200 may be configured to always listen to audio input in an environment, it will be continuously processing the incoming audio for triggers, wherein the triggers may set the system 200 in motion for performing a command. For example, a user may be talking to another user and want to open a document that has a recipe for cooking tuna, so the user may say, “computer, open my tuna recipe,” and system 200 may know what file the user is referring to, or may ask for further clarification. This may not require any direct physical interaction with the system 200 or device 100 other than verbal interaction with the device 100. Moreover, because embodiments of system 200 may be comprised of and/or integrated with a plurality of devices 100, a user may interact with the system 200 to instruct one of the devices 100 integrated with system 200 to perform a variety of tasks/commands/action. For example, a user may utilize system 200 by verbally stating in an environment where at least one device 100 is located to perform various tasks by one or more devices 100 without physically interacting with any of the devices 100. Some examples may include utilizing system 200 by a user to:
turn up/down the heat/AC in the user's house/office
search the web for tuna recipes
do math problems
find any data/information locally on the user's system or on the internet, etc
lock/unlock the doors of the user's house
   Someone rings the user's doorbell. The user says “who's at the door”, the system 200, because it can be listening all the time, may show the user a video feed of the front door, or may open an intercom system channel from the front door, or may access GPS data and be able to determine who it is. The user can then tell the system 200 to open/unlock the door or call the police
find the user's phone
   The user can ask, “where's my phone,” and the system 200 can cause the phone to make a noise that the user could hear to locate it
play specific music
turn the TV on/off, find a program/movie to watch, etc
transfer a file from one person to another
   Thus, embodiments of the system 200 may provide a user with automatic control of multiple, interconnected electronic devices 100 using his voice.

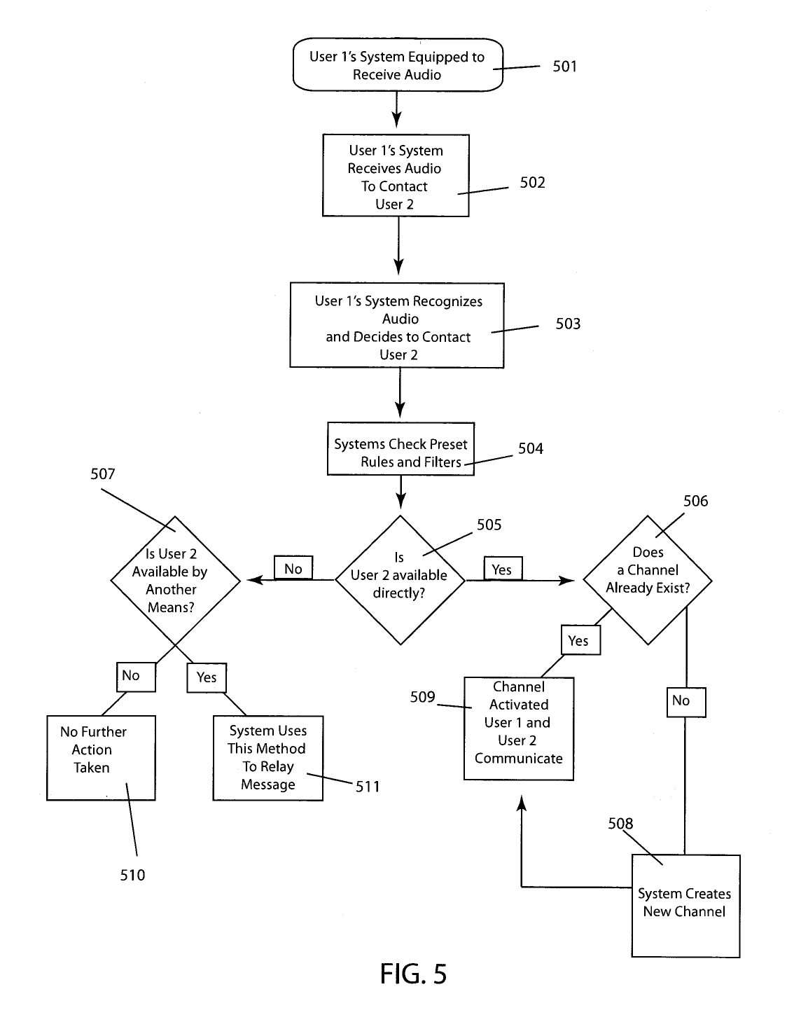

Embodiments of system 200 may also be used for communication. FIG. 5 depicts a flowchart of one embodiment of communication between a first user and a second user utilizing system 200, with no necessary physical interaction with electronic devices 100. Communication may include voice or data communication, such as a voice call, text message, SMS message, MMS message, data file, audio file, video file, audio/visual file, browser executable code, and the like. The communication may be over one or more networks, such as network 7. The first user and second user may be located in the same or different geographic locations, and both the users need not be using system 200. For instance, the first user may be using system 200 through one or more devices 100 to communicate with the second user, regardless if the second user is utilizing system 200. The device 100 of the first user may be capable of and/or configured to be equipped to receive real-world signals, such as audio, as noted in Step 501. However, the devices used by the first and second users may not be specifically built to enable voice input/output, etc.; this coupling may be on a hardware or software level.

In at least one embodiment, the first user may produce audio in a first environment, wherein the audio is collected by the device of the first user because the device 100 and system 200 may be continuously monitoring the first environment for audio and other real-world signals, as noted at Step 502. The device 100 in the first environment may recognize a trigger contained within the collected audio, such as “call second user,” and determine a command event, such as initiate a voice communication with the second user, as indicated at Step 503. At this point, system 200 has determined that the first user would like to communicate with/talk to the second user. At Step 504, system 200 may then check rules and/or filters associated with system 200 and/or device(s) 100. For instance, system 200 determines whether any rules or filters are present, which may affect the performance or execution of the command event by the system 200.

Filtering by the system 200 may allow automatic management of both incoming communication and data (e.g. text/audio, emails, etc.) from external sources, either person-generated or system-generated, and also to outgoing data (e.g. audio input into system). One or more filters may be created by the user or generated by the system 200 to manage communications based on a plurality of factors. Embodiments of the plurality of factors that may be used to manage communications may be a type of communication, a privacy setting, a subject of the communication, a content of the communication, a source of the communication, a GPS location of the source of the communication, a time of the day, an environment, a temperature, a GPS location of the user, a device that is configured to receive the communication, and the like. For example, a user may wish to refuse certain types of communications (e.g. phone calls), yet allow other types of communication (e.g. text messages). Further, a user may wish to ignore communications about a particular subject, but receive communications regarding another subject. In another example, a user may accept a communication during normal business hours, but may not want to be bothered after normal business hours. In yet another embodiment, a user may want to receive only communications that come from family members, or that originate from the office. More than one filter may be utilized and checked by system 200 to create complex or customizable filters for a management of communications by system 200. Moreover, filtering the communication may include one or more modes of managing communication, such as delete, restrict, suppress, store, hold, present upon change, forward immediately, and the like. For instance, filters may instruct system 200 to ignore and never present the communication to the user, to store and/or archive the communication for the user to retrieve at a later date while potentially providing a notification, hold the communication until a change in a status or filter and then immediately notifying or presenting the communication, or a combination thereof. As an example, if a user is in a meeting, with someone, and then leaves the meeting, one or more of the filtered communications may be then be presented to the user. Those skilled in the art should appreciate that the filtering by the system 200 may apply to all aspects of system 200, in addition to person-to-person communication. In just one example, the user may request that the temperature of his home be increased because he is cold at his office and wants to return to a warm house, but the system 200 may filter the request and not raise the temperature because the user has set a maximum temperature of the home.

Moreover, a user could issue one or more emergency words/codes that they could give to another person to use. This trigger may be seen as the filter system as an automatic override and immediately allow the communication through. It could be a general word that could be given to anyone the user wishes to have the ‘override.’ Alternatively, the emergency code/word may be different for each person the user wants to give an override to. For example: User 1 could give User 2 the override word ‘emergency,’ and User 1 could give User 3 the override word ‘volleyball.’ In this case, if User 3 uses ‘emergency’, there is no override—just the standard filters apply and the message/communication is evaluated within the standard ruleset. But if User 3 uses ‘volleyball’ in a communication, then his communication is allowed through with override priority. This feature could be associated with a special notification alarm as well, so as to ensure that the user is notified by all possible means. For example, even if my phone is set to vibrate only, the phone will create a loud notification sound. Embodiments of system 200 may recognize multiple signals, voice commands, text-based codes, etc., to apply one or more override to filters established, generated, selected, or otherwise present.

Referring still to FIG. 5, system 200, after checking any existing filters that may affect further processing by system 200, may determine whether or not the second user is directly available, as indicated at Step 505. Direct availability may be determined by online/offline status, access permissions, current contextual setting, filters, rules, environmental considerations, etc. In an exemplary embodiment, system 200 may determine whether the second user has provided permission for the first user to contact. If the second user is available (e.g. directly available based on permission or other settings), the system 200 may determine whether a communication channel exists between the users, as noted at Step 506. Depending on system 200 setup, properties, etc., an open channel may be maintained that is not transporting communication data but is prepared for activation. If a communication channel does exist between the first and second user, the communication channel may be activated by system 200, as shown at Step 507. Once the communication channel is activated, the second user may immediately be able to hear the first user, as if they are in the same room, and can communicate with each other. If a communication channel does not currently exist, system 200 may create a new communication channel between then first user and the second user, as indicated at Step 508. Creating the communication channel between users need not involve conventional “ringing.” Upon creation of the new communication channel, system 200 may activate the new communication channel, and the users may communication immediately, as if in the same room.

Embodiments of an activated communication channel (i.e. Step 507) may be considered an immediate open channel or a direct communication channel. In this embodiment, the second user has given the first user permission to directly contact him to establish an immediate communication channel. For example, the first user simply needs to say something like: “Second User, want to go sledding?” or “Second User, it's time for dinner, come help me make tuna sandwiches”, or “Second User, are you there”, or “Second User, what do you think about the philosophical implications of ‘brain in a vat’”, etc. As soon as the first user says “Second User” the system 200 may immediately open a live communication channel to Second User, and they can begin communicating directly, without asking the system 200 to open a direct communication channel. In other words, the first and second users can communicate as if they are in the same physical room or near enough to each other physically that if the first user were to just say ‘Second User!’ loudly, the second user would hear him and they could talk; no physical interaction with a device 100 is required for immediate communication. Embodiments of an immediate open communication channel may require that the second user has granted the first user full open-channel access. If there are multiple people the first user may be trying to talk to with the same name or identity as the ‘Second User,’ the system 200 may ask the first user which ‘Second User’ to talk to, or it may learn which ‘Second User’ to open a channel with depending on the content of the first user's statement. If the second user is not available to the first user at the time, the system 200 may automatically send the second user a text version of the communication. Alternatively, if the second user is not available through the immediate open communication channel, the system 200 can choose to call the mobile phone, office phone, text message him, etc based on different system rules and data.

Referring still to FIG. 5, if the second user is not directly available, the system 200 may then determine whether the second user is available by another means, as noted at Step 509. If the second user is not available directly or through alternative means, the system 200 may take no further action to communication with the second user, as depicted by Step 510. However, embodiments of system 200 may utilize another means to communicate if the second user is available through any of the following means, as noted at Step 511.

A first embodiment of another means to communicate with the second user that is not directly available may be requesting a communication channel. In this scenario, the second user may not have granted the first user full, open communication permission. Accordingly, if/when the first user says, “Second User, do tigers like chess or checkers better,” embodiments of system 200 may notify the second user that the first user is attempting to contact him. Embodiments of the system 200 may also send the specific content of the first user's communication to the second user. The second user, or recipient, may decide to open an immediate open channel with the first user, or sender/initiator (e.g. audio, video, text), and the system 200 may activate a communication channel, similar to or the same as the activated communication channel depicted at Step 507. Alternatively, the second user may choose to decline the communication channel request.

A second embodiment of another means to communicate with the second user that is not directly available may be an interpreted communication action. In this scenario, the first user may be having a conversation with a third user (in-person or via a communication system) about chess and he may say—“I think ‘Second User’ may know this. ‘Second User,’ do you know who why tigers are not good at chess?” The system 200 may attempt to open an open immediate communication channel with the Second User immediately, if permissions allow. If the permissions or other settings do allow, the second user may respond, “Because they have no thumbs . . . ” and it may be heard by the first and/or third user. However, embodiments of system 200 may ask the first user if he wants to communicate with the second user prior to requesting a communication channel with the second user, to which the first user may reply affirmatively or negatively, or he may ignore the system prompt, which may be interpreted as a negative response by the system 200.

A third embodiment of another means to communicate with the second user that is not directly available may be a direct command action. In this scenario, the first user may initiate a direct communication channel with the second user by saying something like “Open a channel with ‘Second User.” Embodiments of system 200 may attempt to do so based on permission sets. Such commands may be pre-defined, defined by the user, or intelligently learned by the system.

A fourth embodiment of another means to communicate with the second user that is not directly available may be an indirect command action. In this scenario, the first user can simply tell the system 200 to send a message to the second user rather than opening a direct communication channel with the second user. For example, the first user can send a message saying—“‘Send message to ‘Second User’. I'm having dinner at 6.” The first user may speak the full message and the second user can receive the message in audio/video or text format (or any other available communication medium.

A fifth embodiment of another means to communicate with the second user that is not directly available may be filtered communication. For example, the first user may say, “Second User, I'm having dinner at 6. We′re making tuna sandwiches. Let me know if you want to come over.” Although the second user is not directly available because the second user has not given the first user permission to establish a direct communication channel, if the second user has set a filter on his system 200 to automatically allow any messages about ‘tuna’ through, the system 200 may either automatically open a direct communication channel between the users, ask the second user if he′d like to open a direct communication channel, or send a notification, such as a text-based alert or full message, etc. The particular action taken by the system 200 may be based on the settings or system-determined settings.

Accordingly, various types of communication can be accomplished by utilizing system 200, without physical interaction with one or more devices 100. Moreover, filtering by the system 200 allows a user to control incoming and outgoing communication based on a plurality of factors, circumstances, rules, situations, and the like, and combinations thereof.

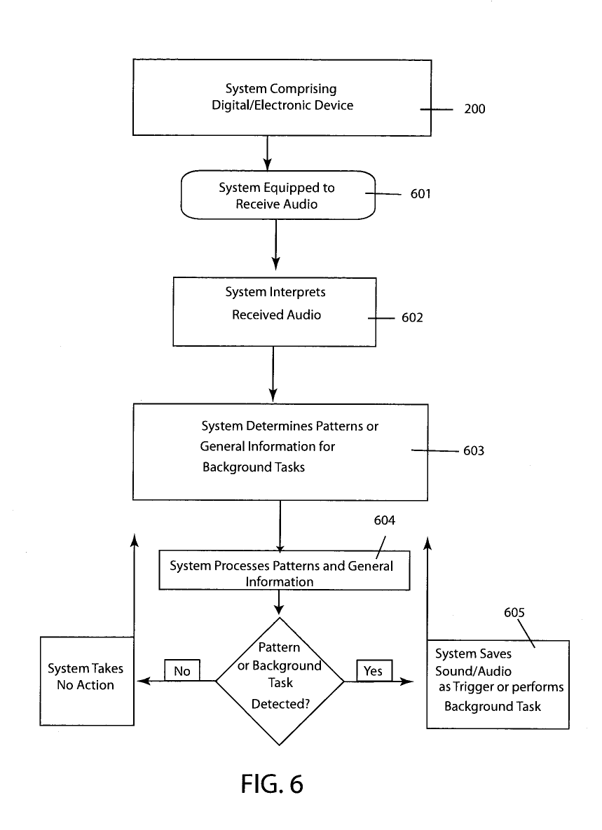

Referring now to FIG. 6, embodiments of system 200 may develop system intelligence. Embodiments of system intelligence may be developing, detecting, and/or recognizing patterns of a user and the user's interaction and operation of one or more devices 100 integrated with system 200 or general information associated with the collected audio. Patterns may be used by system 200 to suggest, develop, learn, etc. triggers for determining a command event or action to perform. Moreover, system intelligence of system 200 may interpret or process general information to perform one or more background tasks based on the collected audio from one or more environments. Embodiments of background tasks may include performing internet searches based on a topic of conversation, or other computer-related background tasks based on the received/collected audio. At Step 601, embodiments of system 200 may include one or more devices 100 for constantly collecting real-world signals, such as audio from an environment. Embodiments of system 200 may interpret the collected audio, as noted at Step 602. Furthermore, at Step 603, system 200 may determine patterns or general information for background tasks that may be performed by the system 200. Further, embodiments of system 200 may process a recognized or determined pattern or task, as noted at Step 604, and then may store determined pattern or begin computer-related task, as noted at Step 605.

In an exemplary embodiment, system 200 may always be listening to a first user and may process the audio it is collecting and interpreting, and decide to run background tasks that the first user may not be immediately aware of. For example, the first user may be talking to a second user about going snowboarding next week. The system may begin to run various searches for data about snowboarding, and the system 200 may present that data to the first user real-time or later. In this case, the system 200 may find lift ticket sales in the first user's area and send an email or text alert of the sale. Further, the system 200 may discover that a third user is also planning on snowboarding next week and may prompt the first user that that the third user is planning the same thing, and ask the first user if he wants to add her to a current live direct communication channel between the first user and the second user. In addition, system 200 may process received audio to learn and suggest new triggers and/or command action based on the user's tendencies. Essentially, embodiments of system 200 may develop system intelligence by continuously evaluating and analyzing the incoming audio and making functional decisions about what to do with that data. Embodiments of system 200 may simply do ongoing analysis of the incoming audio data or it may choose to take actions based on how it interprets the audio data.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

The claims are as follows:

1. A system comprising:
one or more electronic devices integrated over a network, wherein the one or more electronic devices continuously collect audio from an environment;
wherein, when the system recognizes a trigger from the audio received by at least one of the one or more electronic devices, the received audio is processed to determine an action to be performed by the one or more electronic devices;
wherein the system operates without any physical interaction of a user with the one or more electronic devices to perform the action.

2. The system of claim 1, wherein the trigger is a recognizable or unique keyword, an event, a sound, a property, a pattern, a voice command from the user, a volume threshold, a keyword, a unique audio input, a cadence, a song, a ringtone, a text tone, a doorbell, a knock on a door, a dog bark, a GPS location, a motion threshold, a phrase, a proper noun, an address, a light, a temperature, a time of day, or any spoken word or perceptible sound that has a meaning relative to or learned by the system.

3. The system of claim 1, wherein the trigger is at least one of a pre-set system default, manually inputted into the system by the user, automatically developed and generated by system intelligence, and a combination thereof.

4. The system of claim 1, wherein the environment comprises more than one environment.

5. The system of claim 1, wherein the action to be performed is processed at least one of locally and remotely.

6. The system of claim 1, wherein the action to be performed is filtered prior to performing the action.

7. The system of claim 1, wherein the received audio is at least one of permanently stored, temporarily stored, and archived for analysis of the received audio.

8. The system of claim 1, wherein the action to be performed is verified prior to performing the action.

9. The system of claim 1, wherein one or more background tasks are performed by the one or more electronic devices based on the received audio from the environment.

10. The system of claim 1, wherein one or more patterns are detected by the system based on the received audio from the environment.

11. The system of claim 1, wherein at least one of the one or more electronic devices include a microphone for collecting the audio from the environment.

12. A method for hands-free interaction with a computing system, comprising:
continuously collecting audio from an environment by one or more integrated electronic devices;
recognizing, by a processor of the computing system, a trigger in the audio collected by the one or more integrated electronic devices;
after recognizing the trigger, determining, by the processor, a command event to be performed;
checking, by the processor, one or more filters of the computing system; and
performing, by the processor, the command event.

13. The method of claim 12, wherein the processor of the computing system is located at least one of on at least one of the one or more integrated electronic devices and remotely.

14. The method of claim 12, wherein the one or more integrated electronic devices are integrated with the computing system at least one of wired or wirelessly.

15. The method of claim 12, wherein the command event is a command, a reaction, a task, an event, or a combination thereof.

16. The method of claim 12, further comprising:
verifying the command event prior to performing the command event.

17. The method of claim 12, further comprising:
performing, by the processor, one or more background functions based on an interpretation of the collected audio.

18. The method of claim 17, wherein the one or more background functions include an internet search based on a content of the collected audio.

19. The method of claim 12, further comprising:
detecting, by the processor, one or more patterns based on the collected audio.

20. The method of claim 19, wherein the one or more patterns are used to develop additional triggers recognizable by the one or more integrated electronic devices.

21. A computer program product comprising a computer-readable hardware storage device having computer-readable program code stored therein, said program code configured to be executed by a processor of a computer system to implement a method for encoding a connection between a base and a mobile handset, comprising:
continuously collecting audio from an environment by one or more integrated electronic devices;
recognizing, by a processor of the computing system, a trigger in the audio collected by the one or more integrated electronic devices;
after recognizing the trigger, determining, by the processor, a command event to be performed;
checking, by the processor, one or more filters of the computing system; and
performing, by the processor, the command event.

22. The method of claim 21, wherein the processor of the computing system is located at least one of: on at least one of the one or more integrated electronic devices, and remote from the one or more integrated electronic devices.

23. The method of claim 21, wherein the one or more integrated electronic devices are integrated with the computing system at least one of wired or wirelessly.

24. The method of claim 21, wherein the command event is a command, a reaction, a task, an event, or a combination thereof.

25. The method of claim 21, further comprising:
verifying the command event prior to performing the command event.

26. The method of claim 21, further comprising:
performing, by the processor, one or more background functions based on an interpretation of the collected audio.

27. The method of claim 26, wherein the one or more background functions include an internet search based on a content of the collected audio.

28. The method of claim 21, further comprising:
detecting, by the processor, one or more patterns based on the collected audio.

29. The method of claim 28, wherein the one or more patterns are used to develop additional triggers recognizable by the one or more integrated electronic devices.

30. A system for hands-free communication between a first user and a second user, comprising:
a system of integrated electronic devices associated with the first user, the system continuously processing audio from the first user located in a first environment, wherein, when the system recognizes a trigger to open communication with the second user located in a second environment, a communication channel is activated between at least one of the integrated devices and a device of the second user to allow the first user to communicate with the second user;
wherein the first user does not physically interact with any of the integrated electronic devices to establish the communication channel to communicate with the second user.

31. The system of claim 30, wherein the system checks one or more filters prior to activating the communication channel.

32. The system of claim 30, wherein the communication channel is activated immediately to establish an open, immediate communication channel based on a permission granted by the second user.

33. The system of claim 30, wherein the communication channel is activated after a determination that the second user is not directly available.

34. The system of claim 30, wherein the trigger to open communication with the second user may be recognized by the system based on an incoming communication from the device of the second user.

35. The system of claim 30, wherein the trigger to open communication with the second user may be recognized by the system based on a voice command from the first user.

36. A method of communicating between a first user and a second user, comprising:
continuously collecting and processing audio, by one or more integrated electronic devices forming an integrated system associated with the first user, from the first user located in a first environment; and
after a trigger is recognized to open communication with the second user located in a second environment, activating a communication channel between at least one of the integrated electronic devices and a device of the second user to allow the first user to communicate with the second user;
wherein the first user does not physically interact with any of the integrated electronic devices to establish the communication channel to communicate with the second user.

37. The method of claim 36, further comprising:
checking one or more filters prior to activating the communication channel; and
determining whether the second user is directly available.

38. The method of claim 36, wherein the communication channel is activated immediately to establish an open immediate communication channel based on a permission granted by the second user.

39. The method of claim 36, wherein the communication channel is activated after a determination that the second user is not directly available.

40. The system of claim 36, wherein the trigger to open communication with the second user may be recognized by the system based on an incoming communication from the device of the second user.

41. The system of claim 36, wherein the trigger to open communication with the second user may be recognized by the system based on a voice command from the first user.

42. A computer program product comprising a computer-readable hardware storage device having computer-readable program code stored therein, said program code configured to be executed by a processor of a computer system to implement a method for encoding a connection between a base and a mobile handset, comprising:
continuously collecting and processing audio, by one or more integrated electronic devices forming an integrated system associated with the first user, from the first user located in a first environment; and
after a trigger is recognized to communicate with the second user located in a second environment, activating a communication channel between at least one of the integrated electronic devices and a device of the second user to allow the first user to communicate with the second user;
wherein the first user does not physically interact with any of the integrated electronic devices to establish the communication channel to communicate with the second user.

43. The method of claim 42, further comprising:
checking one or more filters prior to activating the communication channel; and
determining whether the second user is directly available.

44. The method of claim 42, wherein the communication channel is activated immediately to establish an open immediate communication channel based on a permission granted by the second user.

45. The method of claim 42, wherein the communication channel is activated after a determination that the second user is not directly available.
